(19) United States
(12) Patent Application Publication
(10) Pub. No.: US 2024/0238713 A1
(43) Pub. Date: Jul. 18, 2024

(54) SERVICE COVER FOR INSTALLING AND REMOVING FILTER ELEMENTS OF A FILTER ASSEMBLY

(71) Applicant: Caterpillar Inc., Peoria, IL (US)

(72) Inventor: Timothy Sean FINN, Morton, IL (US)

(73) Assignee: Caterpillar Inc., Peoria, IL (US)

(21) Appl. No.: 18/156,097

(22) Filed: Jan. 18, 2023

(51) Int. Cl. B01D 46/42; B01D 46/00; B01D 46/64

(52) U.S. Cl. CPC B01D 46/4227; B01D 46/0004; B01D 46/64; B01D 2265/021

(57) ABSTRACT

A cover for a filter assembly, of a machine, may comprise a first surface comprising a first recessed surface and a second surface, opposite the first surface, comprising a second recessed surface. The first recessed surface may be configured to engage with a first end of a first element of the filter assembly. The second recessed surface may be configured to engage with a second end of a second element of the filter assembly. The cover may be configured to install the first element in an opening of the filter assembly and to remove the first element from the opening. The cover may be configured to install the second element in the opening over the first element and to remove the second element from the opening.

### TECHNICAL FIELD

The present disclosure relates generally to a cover for a filter assembly and, for example, to a cover for installing and removing filter elements of a filter assembly.

### BACKGROUND

A work machine may include a filter assembly. The filter assembly typically includes an air inlet configured to receive air (e.g., ambient air), multiple elements (or filter elements) configured to filter the air to obtain filtered air, and an air outlet configured to provide the filtered air to an engine of the work machine. The elements may be inserted into an opening of the filter assembly and may be covered by a service cover.

The service cover may be removed when the filter assembly is to be serviced or the elements are to be replaced. Typically, an individual (e.g., an operator, a technician, and/or field personnel) would remove the service cover and remove the elements manually. Removing the elements manually is a difficult and time consuming task due to deterioration of sealing material used with the filter assembly.

Typically, the sealing material (e.g., urethane) is provided around an outlet of a housing of the filter assembly. Over a period of time, heat and humidity of a working environment (e.g., a construction environment) causes the sealing material to adhere to the outlet. Accordingly, removing the elements manually may require an excessive amount of force. However, a location of the filter assembly (on the work machine) may prevent the excessive amount of force from being applied. Accordingly, the individual may be required to carry a tool that is used to remove the elements. In this regard, if the individual fails to carry the tool, the work machine may be subject to an unexpected amount of downtime caused by manually removing the elements.

U.S. Pat. No. 9,586,166 (the '166 patent) discloses an air cleaner assembly, a main filter element, a safety element, combinations and methods for servicing an air cleaner assembly. The '166 patent further discloses that the air cleaner assembly includes an air cleaner housing and a main filter element. Additionally, the '166 patent discloses that the air cleaner housing includes a safety liner that supports the main filter element, and can be configured to help reduce the tendency of the main filter element to rotate during use of the air cleaner assembly. Furthermore, the '166 patent discloses that the air cleaner housing includes a main housing and a service cover.

While the '166 patent discloses that the air cleaner housing includes a main housing and a service cover, the '166 patent does not disclose or suggest that the service cover addresses the above-described issues associated with removing filter elements from a filter assembly.

The service cover of the present disclosure solves one or more of the problems set forth above and/or other problems in the art.

### SUMMARY

In some implementations, a cover for a filter assembly includes a first surface comprising a first recessed surface, wherein the first recessed surface is configured to engage with a first end of a first element of the filter assembly; and a second surface, opposite the first surface, comprising a second recessed surface, wherein the second recessed surface is configured to engage with a second end of a second element of the filter assembly, wherein the cover is configured to install the first element in an opening of the filter assembly and to remove the first element from the opening of the filter assembly when the first recessed surface is engaged with the first end of the first element, and wherein the cover is configured to install the second element in the opening of the filter assembly over the first element and to remove the second element from the opening of the filter assembly when the second recessed surface is engaged with the second end of the second element.

In some implementations, a method of using a cover for a filter assembly includes using a first surface of the cover to engage with a first end of a first element of the filter assembly; using the cover to install the first element in an opening of the filter assembly or to remove the first element from the opening after the first surface of the cover engages with the first end of the first element; using a second surface of the cover to engage with a second end of the second element of the filter assembly, wherein the second surface is opposite the first surface; and using the cover to install the second element in the opening or to remove the second element from the opening after the second surface of the cover engages with the second end of the second element.

In some implementations, a system comprises: a filter assembly comprising a first element and a second element; and a cover comprising: an outer surface comprising a first recessed surface, wherein the first recessed surface is configured to engage with a first end of the first element, and an inner surface comprising a second recessed surface, wherein the second recessed surface is configured to engage with a second end of the second element, wherein the cover is configured to remove the first element from the filter assembly when the first recessed surface is engaged with the first end of the first element, and wherein the cover is configured to remove the second element from the filter assembly when the second recessed surface is engaged with the second end of the second element.

### BRIEF DESCRIPTION OF THE DRAWINGS

FIG. 1 is a diagram of an example a filter assembly described herein.

FIG. 2 is a diagram of an example described herein.

FIG. 3 is a diagram of an example described herein.

FIG. 4 is a diagram of a cross-sectional perspective view of a service cover and a filter assembly described herein.

FIG. 5 is a diagram of a cross-sectional view of a service cover and a filter assembly described herein.

FIG. 6 is a flowchart of an example process relating to using the service cover to install and remove a filter assembly.

### DETAILED DESCRIPTION

Implementations described herein are directed to a service cover for a filter assembly of a machine. The service cover may be configured to operate as a tool for installing and removing elements of the filter assembly. The elements may be configured to be installed in an opening (or cavity) of the filter assembly. For example, a first element of the filter assembly may be installed in the opening and a second element of the filter assembly may be installed in the opening over the first element. The service cover may be configured to install the elements in the filter assembly and to remove the elements from the filter assembly. For example, the service cover may be used to rotate (e.g., in a first direction) and tighten the elements in the filter assembly. Conversely, the service cover may be used to rotate (e.g., in a second direction) and loosen the elements in the filter assembly.

In some implementations, a first surface (e.g., outer surface) of the service cover may be configured to install the first element in the opening of the filter assembly and to remove the first element from the opening. A second surface (e.g., inner surface) of the service cover may be configured to install the second element in the opening of the filter assembly and to remove the second element from the opening. The first element may be referred to as a safety element or a secondary element. The second element may be referred to as a primary element.

The first surface of the service cover may include a first recessed surface. An end of the first element may include a protruding surface. A shape of an outer perimeter of the first recessed surface may correspond to a shape of a protruding surface of the end of the first element. For example, the shape of the outer perimeter of the first recessed surface may be the same or substantially the same as the shape of the protruding surface of the first element.

When installing the first element in the filter assembly or removing the first element from the filter assembly, the first recessed surface (of the first surface of the service cover) may engage with the protruding surface of the first element. In this regard, when installing the first element, the service cover may be used to rotate (e.g., in the first direction) and tighten the first element in the filter assembly. Conversely, when removing the first element, the service cover may be used to rotate (e.g., in the second direction) and loosen the first element in the filter assembly.

The second surface of the service cover may include a second recessed surface. An end of the second element may include a protruding surface. A shape of an outer perimeter of the second recessed surface may correspond to a shape of the protruding surface of the end of the second element. For example, the shape of the outer perimeter of the second recessed surface may be the same or substantially the same as the shape of the protruding surface of the second element.

When installing the second element in the filter assembly (over the first element) or removing the second element from the filter assembly, the second recessed surface (of the second surface of the service cover) may engage with the protruding surface of the second element. In this regard, when installing the second element, the service cover may be used to rotate (e.g., in the first direction) and tighten the second element in the filter assembly. Conversely, when removing the second element, the service cover may be used to rotate (e.g., in the second direction) and loosen the second element in the filter assembly.

Accordingly, the service cover may be configured to operate as a tool for installing and removing the elements of the filter assembly. For example, the first surface of the service cover may be configured to operate as a first tool (e.g., a first wrench) that is used in conjunction with the first element and the second surface of the service cover may be configured to operate as a second tool (e.g., a second wrench) that is used in conjunction with the second element.

The term “machine” may refer to a device that performs an operation associated with an industry such as, for example, mining, construction, farming, transportation, or another industry. Moreover, one or more implements may be connected to the machine. As an example, a machine may include a construction vehicle, a work vehicle, or a similar vehicle associated with the industries described above.

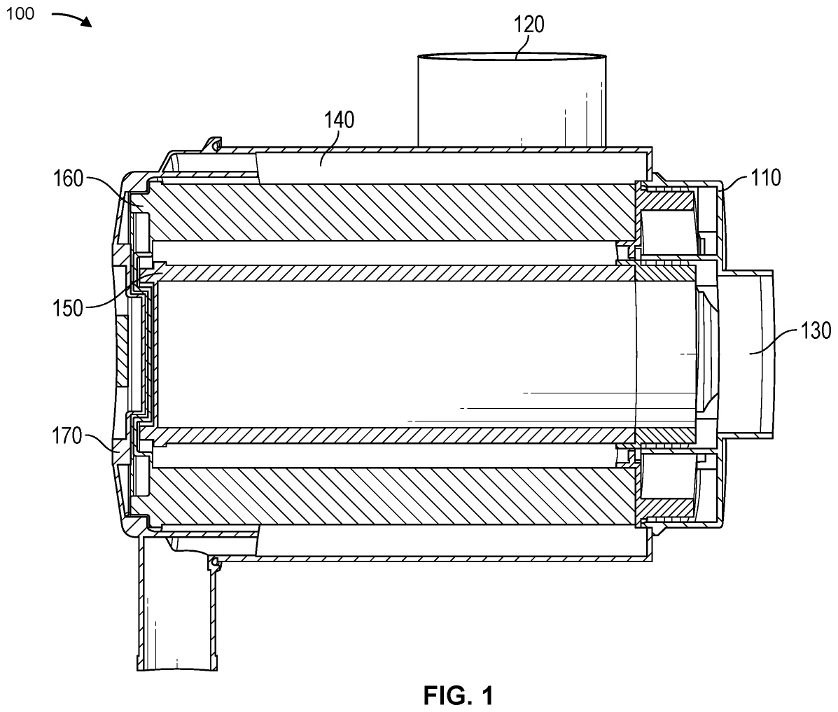

FIG. 1 is a diagram of an example filter assembly 100 described herein. As shown in FIG. 1, filter assembly 100 may include a housing 110 that includes an air inlet 120, an air outlet 130, an opening 140, filter elements (that include a first element 150 and a second element 160), and a service cover 170. In some implementations, filter assembly 100 may be included in a machine and may be used in conjunction with an engine of a machine. For example, filter assembly 100 may be configured to filter air that is to be provided to the engine during a combustion process. For instance, filter assembly 100 may be used to filter contaminants, debris, and/or other impurities in the air using the filter elements.

Air inlet 120 may be configured to receive the air. The air may include ambient air. Air inlet 120 may be configured to direct the air to opening 140 that includes the filter elements. First element 150 and second element 160 may be configured to filter the air. In some situations, the air may move (e.g., rotate) around the filter elements and housing 110 during a filtration process.

As shown in FIG. 1, first element 150 may be installed in opening 140 and second element 160 may be installed in opening 140 over first element 150. First element 150 may function as a safety element or secondary element for filtering the air, while second element 160 may function as a primary element for filtering the air. For example, first element 150 may provide an additional filtration capability in the event second element 160 is damaged by debris and/or experiences a failure due to the debris. Accordingly, first element 150 may prevent damage to the engine of the machine.

The filter elements may filter the air to obtain filtered air. The filtered air may be provided to air outlet 130. Air outlet 130 may be configured to provide filtered air to the engine as a part of a combustion process.

Service cover 170 may be detachably coupled to housing 110. As explained herein, service cover 170 may be configured to operate as a tool for installing and removing first element 150 and second element 160. Additionally, service cover 170 may prevent an axial movement of second element 160, thereby preventing second element 160 from being removed from opening 140. Accordingly, service cover 170 may cause second element 160 to prevent an axial movement of first element 150, thereby preventing first element 150 from being removed from opening 140.

As indicated above, FIG. 1 is provided as an example. Other examples may differ from what is described in connection with FIG. 1.

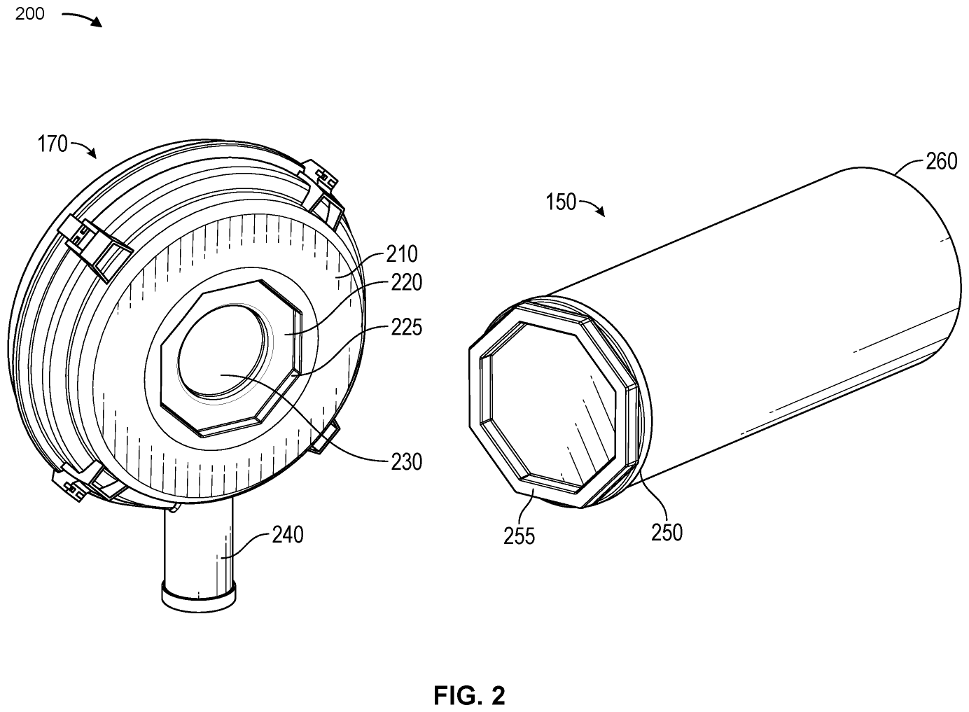

FIG. 2 is a diagram of an example 200 described herein. As shown in FIG. 2, example 200 includes service cover 170 and first element 150. As shown in FIG. 2, service cover 170 may include a first surface 210. First surface 210 may be an outer surface of service cover 170. As shown in FIG. 2, first surface 210 may include a first recessed surface 220. In some examples, a shape of a first outer perimeter 225 of first recessed surface 220 may be a polygon. As shown in FIG. 2, the shape may be an octagon. Alternatively, the shape may be a triangle, a square, a rectangle, and/or another geometric shape with multiple edges, among other examples.

First surface 210 may further include an additional recessed surface 230 and a handle 240. Handle 240 may be referred and may function as a dust evacuation tube during an air filtration process. As shown in FIG. 2, a shape of additional recessed surface 230 may be a circle. Alternatively, the shape of additional recessed surface 230 may be a triangle, a square, a rectangle, and/or another geometric shape with multiple edges, among other examples. In some situations, handle 240 may be used to apply a rotational force (e.g., a torquing force) to rotate service cover 170 in a first direction (e.g., clockwise) or in a second direction (e.g., counterclockwise). The rotational force may be to install and/or remove first element 150 and second element 160.

As shown in FIG. 2, first element 150 may include a first end 250 and a second end 260. Second end 260 may be opposite first end 250 and may be provided adjacent to air outlet 130. First end 250 may include a first protruding surface 255. The shape of first outer perimeter 225 of first recessed surface 220 may correspond to a shape of first protruding surface 255. For example, the shape of first outer perimeter 225 may be similar to or the same as the shape of first protruding surface 255. In some implementations, the shape of first outer perimeter 225 may be slightly larger than the shape of first protruding surface 255 to enable first protruding surface 255 to fit (snuggly) inside first outer perimeter 225. In this regard, first recessed surface 220 of service cover 170 may be configured to engage with first protruding surface 255 of first element 150.

When first recessed surface 220 of service cover 170 is engaged with first protruding surface 255 of first element 150, service cover 170 may be rotated (e.g., using handle 240) in the first direction to install first element 150 in filter assembly 100. For example, service cover 170 may be used to rotate (e.g., in the first direction) and tighten first element 150 in filter assembly 100 (e.g., in opening 140). Conversely, service cover 170 may be rotated (e.g., using handle 240) in the second direction to remove first element 150 from filter assembly 100. For example, service cover 170 may be used to rotate (e.g., in the second direction) and loosen first element 150 in filter assembly 100 (e.g., in opening 140).

As indicated above, FIG. 2 is provided as an example. Other examples may differ from what is described in connection with FIG. 2.

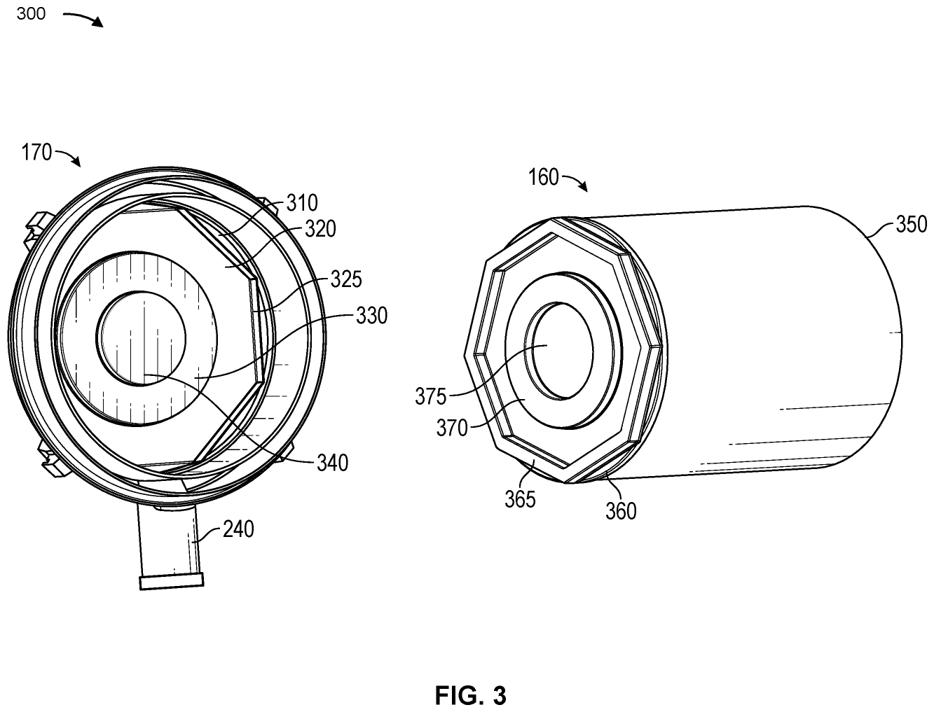

FIG. 3 is a diagram of an example 300 described herein. As shown in FIG. 3, example 300 includes service cover 170 and second element 160. As shown in FIG. 3, service cover 170 may include a second surface 310. Second surface 310 may be an inner surface of service cover 170. As shown in FIG. 3, second surface 310 may include a second recessed surface 320. In some examples, a shape of a second outer perimeter 325 of second recessed surface 320 may be a polygon. As shown in FIG. 3, the shape may be an octagon. Alternatively, the shape may be a triangle, a square, a rectangle, and/or another geometric shape with multiple edges, among other examples.

Second surface 310 may further include an intermediate surface 330 and an inner protruding surface 340 surrounded by intermediate surface 330. As shown in FIG. 2, a shape of intermediate surface 330 may be a circle. Alternatively, the shape of intermediate surface 330 may be a triangle, a square, a rectangle, and/or another geometric shape with multiple edges, among other examples. Similarly, a shape of inner protruding surface 340 may be a circle. Alternatively, the shape of inner protruding surface 340 may be a triangle, a square, a rectangle, and/or another geometric shape with multiple edges, among other examples.

As shown in FIG. 3, second element 160 may include a first end 350 and a second end 360. First end 350 may be opposite second end 360 and may be provided adjacent to air outlet 130. Second end 360 may include a second protruding surface 365, a third protruding surface 370, and a third recessed surface 375. The shape of second outer perimeter 325 of second recessed surface 320 may correspond to a shape of second protruding surface 365. For example, the shape of second outer perimeter 325 may be similar to or the same as the shape of second protruding surface 365. In some implementations, the shape of second outer perimeter 325 may be slightly larger than the shape of second protruding surface 365 to enable second protruding surface 365 to fit (snuggly) inside second outer perimeter 325. In this regard, second recessed surface 320 of service cover 170 may be configured to engage with second protruding surface 365 of second element 160.

When second recessed surface 320 of service cover 170 is engaged with second protruding surface 365 of second element 160, service cover 170 may be rotated (e.g., using handle 240) in the first direction to install second element 160 in filter assembly 100 (over first element 150). For example, service cover 170 may be used to rotate (e.g., in the first direction) and tighten second element 160 in filter assembly 100 (e.g., in opening 140). Conversely, service cover 170 may be rotated (e.g., using handle 240) in the second direction to remove second element 160 from filter assembly 100. For example, service cover 170 may be used to rotate (e.g., in the second direction) and loosen second element 160 in filter assembly 100 (e.g., in opening 140).

As shown in FIG. 3, in some examples, the shape of intermediate surface 330 of second recessed surface 320 may correspond to a shape of third protruding surface 370 of second element 160. For example, the shape of intermediate surface 330 may be similar to or the same as the shape of third protruding surface 370. Similarly, the shape of inner protruding surface 340 of second recessed surface 320 may correspond to a shape of third recessed surface 375 of second element 160. For example, the shape of inner protruding surface 340 may be similar to or the same as the shape of third recessed surface 375.

In this regard, third recessed surface 375 of second element 160 may be configured to engage with inner protruding surface 340 of service cover 170. Accordingly, inner protruding surface 340 may be configured to prevent an axial movement of second element 160.

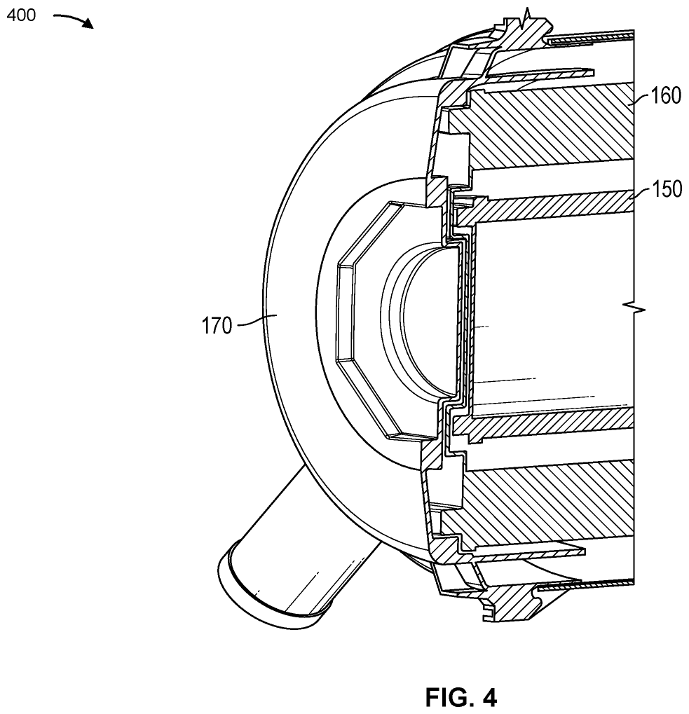

FIG. 4 is a diagram 400 of a cross-sectional perspective view of service cover 170 and a filter assembly described herein. As shown in FIG. 4, first element 150 may be installed in opening 140 of filter assembly 100, second element 160 may be installed in opening 140 of air filter assembly 100 over first element 150, and service cover 170 may be coupled to housing 110 over second element 160. When coupled to housing 110 in this manner, service cover 170 may be configured to limit or prevent an axial movement of second element 160. Accordingly, service cover 170 may be configured to prevent second element 160 from being removed out of opening 140. In this regard, service cover 170 may be configured to cause second element 160 to limit or prevent an axial movement of first element 150, thereby preventing first element 150 from being removed out of opening 140.

As indicated above, FIG. 4 is provided as an example. Other examples may differ from what is described in connection with FIG. 4.

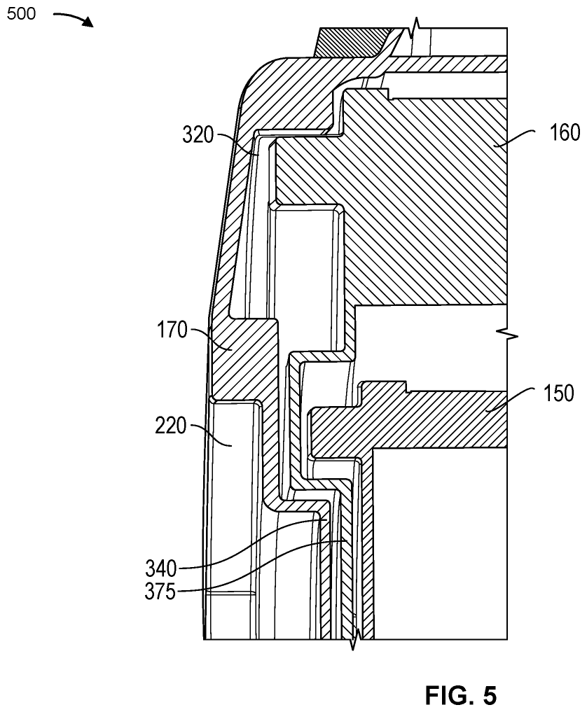

FIG. 5 is a diagram of a cross-sectional view 500 of a service cover and a filter assembly described herein. As shown in FIG. 5, first element 150 may be installed in opening 140 of air filter assembly 100, second element 160 may be installed in opening 140 of air filter assembly 100 over first element 150, and service cover 170 may be coupled to housing 110 over second element 160.

As shown in FIG. 5, a size of first recessed surface 220 may different than a size of second recessed surface 320. For example, the size of second recessed surface 320 may exceed the size of first recessed surface 220. For instance, a size of the shape of second outer perimeter 325 of second recessed surface 320 may exceed a size of the shape of first outer perimeter 225 of first recessed surface 220. In this regard, a first length of second outer perimeter 325 of second recessed surface 320 exceeds a second length of first outer perimeter 225 of first recessed surface 220.

As shown in FIG. 5, third recessed surface 375 of second element 160 may be configured to engage with inner protruding surface 340 of second surface 310. Accordingly, inner protruding surface 340 may be configured to limit an axial movement of second element 160. By limiting the axial movement of second element 160, second surface 310 may be configured to prevent a rotational movement of second element 160 when second surface 310 engages with second end 360 of second element 160.

Based on the axial movement of second element 160 being limited, third recessed surface 375 may be configured to limit an axial movement of first element 150. For example, third recessed surface 375 may be configured to interface with first end 250 to limit the axial movement of first element 150.

As indicated above, FIG. 5 is provided as an example. Other examples may differ from what is described in connection with FIG. 5.

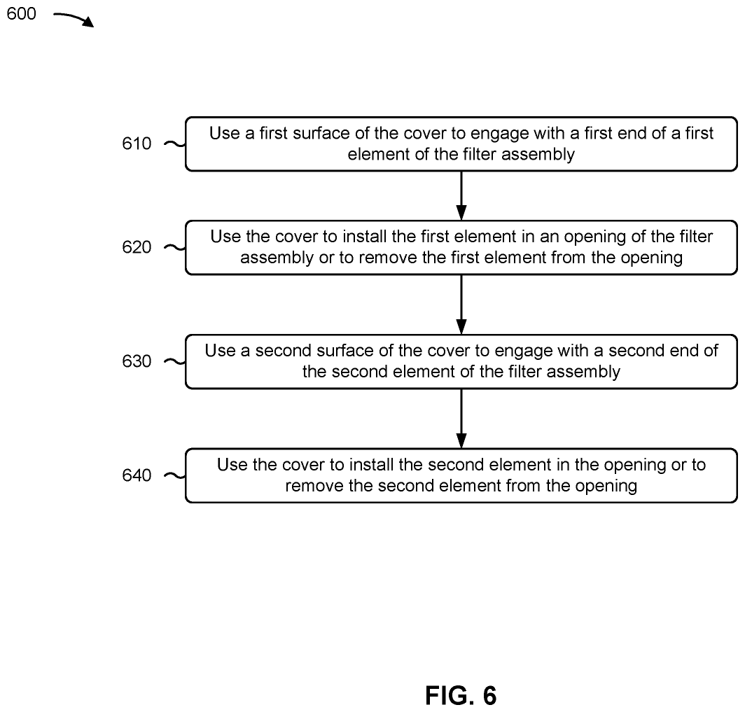

FIG. 6 is a flowchart of an example process 600 relating to using the service cover to install and remove a filter assembly. In some implementations, one or more process blocks of FIG. 6 may be performed by a device.

As shown in FIG. 6, process 600 may include using a first side of the cover to engage with a first end of a first element of the filter assembly (block 610).

As further shown in FIG. 6, process 600 may include using the cover to install the first element in an opening of the filter assembly or to remove the first element from the opening after the first side of the cover engages with the first end of the first element (block 620).

As further shown in FIG. 6, process 600 may include using a second side of the cover to engage with a second end of the second element of the filter assembly, wherein the second side is opposite the first side (block 630).

As further shown in FIG. 6, process 600 may include using the cover to install the second element in the opening or to remove the second element from the opening after the second side of the cover engages with the second end of the second element (block 640).

In some implementations, using the cover to install the first element in the opening or to remove the first element from the opening comprises rotating the cover in a first direction to install the first element in the opening, and rotating the cover in a second direction to remove the first element from the opening.

In some implementations, using the cover to install the second element in the opening or to remove the second element from the opening comprises rotating the cover in a first direction to install the second element in the opening, and rotating the cover in a second direction to remove the second element from the opening.

In some implementations, the first side is an outer surface of the cover, and the second side is an inner surface of the cover.

In some implementations, using the first side of the cover to engage with the first end of the first element comprises using a recessed surface of the first side to engage with the first end of the first element of the filter assembly, a shape of an outer perimeter of the recessed surface corresponds to a shape of a protruding surface of the first end of the first element, and the shape, of the outer perimeter of the recessed surface, is a polygon.

In some implementations, using the second side of the cover to engage with the second end of the second element comprises using a recessed surface of the second side to engage with the second end of the second element, a shape of an outer perimeter of the recessed surface corresponds to a shape of a protruding surface of the second end of the second element, and the shape, of the outer perimeter of the recessed surface, is a polygon.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

### INDUSTRIAL APPLICABILITY

Implementations described herein are directed to a service cover for a filter assembly of a machine. The service cover may be configured to operate as a tool for installing and removing elements of the filter assembly. The elements may be configured to be installed in an opening (or cavity) of the filter assembly. The service cover may be configured to install the elements in the filter assembly and to remove the elements from the filter assembly. For example, an outer surface of the service cover may be used to install or remove a first element (e.g., safety or secondary element) of the filter assembly. An inner surface of the service cover may be used to install or remove a second element (e.g., primary element) of the filter assembly.

Accordingly, the service cover described herein removes the requirement for an individual (e.g., an operator, a technician, a field personnel) to carry a tool to remove and/or install the elements in the filter assembly. In this regard, the service cover may prevent any unexpected downtime of the machine resulting from the individual failing to bring a tool to service or replace the filter assembly.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations cannot be combined. Even though particular combinations of features are recited in the claims and/or disclosed in the specification, these combinations are not intended to limit the disclosure of various implementations. Although each dependent claim listed below may directly depend on only one claim, the disclosure of various implementations includes each dependent claim in combination with every other claim in the claim set.

As used herein, “a,” “an,” and a “set” are intended to include one or more items, and may be used interchangeably with “one or more.” Further, as used herein, the article “the” is intended to include one or more items referenced in connection with the article “the” and may be used interchangeably with “the one or more.” Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “above,” “upper,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A cover for a filter assembly, the cover comprising:
a first surface comprising a first recessed surface,
wherein the first recessed surface is configured to engage with a first end of a first element of the filter assembly; and
a second surface, opposite the first surface, comprising a second recessed surface,
wherein the second recessed surface is configured to engage with a second end of a second element of the filter assembly,
wherein the cover is configured to install the first element in an opening of the filter assembly and to remove the first element from the opening of the filter assembly when the first recessed surface is engaged with the first end of the first element, and
wherein the cover is configured to install the second element in the opening of the filter assembly over the first element and to remove the second element from the filter assembly when the second recessed surface is engaged with the second end of the second element.

2. The cover of claim 1, wherein the first surface is an outer surface of the cover, and
wherein the second surface is an inner surface of the cover.

3. The cover of claim 1, wherein a shape of an outer perimeter of the first recessed surface corresponds to a shape of a protruding surface of the first end of the first element, and
wherein the first recessed surface is configured to engage with the protruding surface.

4. The cover of claim 1, wherein a shape of an outer perimeter of the second recessed surface corresponds to a shape of a protruding surface of the second end of the second element, and
wherein the second recessed surface is configured to engage with the protruding surface.

5. The cover of claim 1, wherein the second recessed surface is configured to prevent a rotational movement of the second element when the second recessed surface engages with the second end of the second element.

6. The cover of claim 1, wherein the second surface further includes a protruding surface configured to engage with a third recessed surface of the second element, and
wherein the cover is configured to prevent an axial movement of the second element when the second recessed surface engages with the second end of the second element and when the protruding surface engages with the third recessed surface of the second element.

7. The cover of claim 1, wherein the cover is configured to cause the second element to prevent an axial movement of the first element within the second element.

8. A method of using a cover for a filter assembly, the method comprising:
using a first surface of the cover to engage with a first end of a first element of the filter assembly;
using the cover to install the first element in an opening of the filter assembly or to remove the first element from the opening after the first surface of the cover engages with the first end of the first element;
using a second surface of the cover to engage with a second end of a second element of the filter assembly,
wherein the second surface is opposite the first surface; and
using the cover to install the second element in the opening or to remove the second element from the opening after the second surface of the cover engages with the second end of the second element.

9. The method of claim 8, wherein using the cover to install the first element in the opening or to remove the opening from the second element comprises:
rotating the cover in a first direction to install the first element in the opening; and
rotating the cover in a second direction to remove the first element from the opening.

10. The method of claim 8, wherein using the cover to install the second element in the opening or to remove the second element from the opening comprises:
rotating the cover in a first direction to install the second element in the opening; and
rotating the cover in a second direction to remove the second element from the opening.

11. The method of claim 8, wherein the first surface is an inner surface of the cover, and
wherein the second surface is an outer surface of the cover.

12. The method of claim 8, wherein using the first surface of the cover to engage with the first end of the first element comprises:
using a recessed surface of the first surface to engage with the first end of the first element of the filter assembly,
wherein a shape of an outer perimeter of the recessed surface corresponds to a shape of a protruding surface of the first end of the first element, and
wherein the shape, of the outer perimeter of the recessed surface, is a polygon.

13. The method of claim 8, wherein using the second surface of the cover to engage with the second end of the second element comprises:
using a recessed surface of the second surface to engage with the second end of the second element,
wherein a shape of an outer perimeter of the recessed surface corresponds to a shape of a protruding surface of the second end of the second element, and
wherein the shape, of the outer perimeter of the recessed surface, is a polygon.

14. A system comprising:
a filter assembly comprising a first element and a second element; and
a cover comprising:
an outer surface comprising a first recessed surface,
wherein the first recessed surface is configured to engage with a first end of the first element, and
an inner surface comprising a second recessed surface,
wherein the second recessed surface is configured to engage with a second end of the second element,
wherein the cover is configured to remove the first element from the filter assembly when the first recessed surface is engaged with the first end of the first element, and
wherein the cover is configured to remove the second element from the filter assembly when the second recessed surface is engaged with the second end of the second element.

15. The system of claim 14, wherein a shape of an outer perimeter of the first recessed surface corresponds to a shape of a protruding surface of the first end of the first element.

16. The system of claim 15, wherein a shape of an outer perimeter of the second recessed surface corresponds to a shape of a protruding surface of the second end of the second element.

17. The system of claim 16, wherein the shape, of the outer perimeter of the first recessed surface, is a polygon, and
wherein the shape, of the outer perimeter of the second recessed surface, is a polygon.

18. The system of claim 16, wherein a first length of the outer perimeter of the second recessed surface exceeds a second length of the outer perimeter of the first recessed surface.

19. The system of claim 14, wherein the second recessed surface is configured to prevent a rotational movement of the second element when the second recessed surface engages with the second end of the second element.

20. The system of claim 14, wherein the inner surface further includes a protruding surface configured to engage with a third recessed surface of the second element, and
wherein the cover is configured to prevent an axial movement of the second element.
